(19) United States
(12) Patent Application Publication
(10) Pub. No.: US 2011/0157275 A1
(43) Pub. Date: Jun. 30, 2011

(54) Liquid jet head and liquid jet apparatus

(76) Inventor: Yuzuru Kubota, Chiba-shi (JP)

(21) Appl. No.: 12/928,573

(22) Filed: Dec. 14, 2010

(30) Foreign Application Priority Data
Dec. 25, 2009 (JP) 2009-294655

(51) Int. Cl. B41J 23/00; B41J 2/175

(52) U.S. Cl. 347/37; 347/85

(57) ABSTRACT

To reduce a thickness of a liquid jet head (1) having two nozzle columns, and reduce unevenness of discharge speed of a liquid droplet jetted from respective nozzles, provided is the liquid jet head (1) including: an actuator chip (3) including a first actuator (2a) and a second actuator (2b) on one surface (4) side and on another surface (5) side, respectively, of a substrate (12); a first flow path member (11a) and a second flow path member (11b) placed on both sides of the actuator chip (3); and a connecting member (14) for dividing and supplying liquid to the first flow path member (11a) and the second flow path member (11b). The first flow path member (11a) and the second flow path member (11b) include therein a first liquid supply chamber (9a) and a second liquid supply chamber (9b), respectively, which are elongated regions. Cross-sectional areas of the first liquid supply chamber (9a) and the second liquid supply chamber (9b) in a direction orthogonal to a direction of a long side are formed to gradually decrease from a liquid inflow side to an opposite side thereof.

### BACKGROUND OF THE INVENTION

1. Field of the Invention

The present invention relates to a liquid jet head for forming an image, a character, or a thin film material on a recording medium by discharging liquid from a nozzle and to a liquid jet apparatus using the same.

2. Description of the Related Art

In recent years, there has been used an ink jet type liquid jet head for discharging an ink droplet on recording paper or the like to render a character or graphics or for discharging a liquid material on a surface of an element substrate to form a functional thin film. In the liquid jet head of this type, ink or a liquid material is supplied from a liquid tank via a supply tube to the liquid jet head and the capacity of a channel filled with ink of the liquid jet head is changed according to a drive signal to discharge ink from a nozzle which communicates to the channel. When ink is discharged, the liquid jet head or a recording medium on which jetted liquid performs recording is moved to record a character or graphics or to form a functional thin film in a predetermined shape.

Japanese Patent Application Laid-open No. 2004-90492 describes this kind of ink jet head. The ink jet head includes a head chip for discharging ink, a manifold for supplying ink to the head chip, a flow path forming portion for guiding ink to the manifold, a flow path connector for causing ink to flow in the flow path forming portion, a drive circuit substrate connected to the head chip, for driving a piezoelectric element of the head chip, and a housing frame for supporting them. FIG. 6A is an exploded perspective view of two manifolds 116a and 116b for supplying ink to the head chip, FIG. 6B is a bottom view of a housing frame 114 for housing the manifolds by covering the manifolds from above, and FIG. 6C is a top view of a cap receiving plate 117 for housing the manifolds by covering the manifolds from below.

A head chip 115 is in the shape of an elongated plate, and a plurality of ink flow paths for pressurizing and discharging ink are formed on both sides thereof. Each of the ink flow paths communicates to a nozzle of a nozzle column formed in a lower end surface of the head chip 115. Ink pressurized by the ink flow paths is discharged from nozzles in the lower end surface. The two manifolds 116a and 116b are fixed to both sides of the head chip 115 so as to be able to supply ink to the ink flow paths formed in the respective surfaces.

A supply recess portion 116c into which ink is filled and an ink inflow tube 116d for guiding ink to the supply recess portion 116c are placed in the manifolds 116a and 116b. Further, a filter placement portional which is a groove for placing a filter therein is formed on the periphery of the supply recess portion 116c on the head chip side. The two manifolds 116a and 116b sandwich the head chip 115 and engaging claws 116g engage with support bases 116i, respectively, to carry out fixation.

An elongated opening is formed at the center of the housing frame 114, and the head chip 115 pierces the opening and is attached. A box-like communicating portion 114s is formed at a right end of the housing frame 114 and ink which flows in from an ink flow path 114r may be stored therein. A groove portion 114u which is a semicircular notch is formed in a top surface of the communicating portion 114s to receive the ink inflow tubes 116d of the manifolds 116a and 116b. An elongated opening 117a for exposing the lower end surface of the head chip 115 is formed at the center of the cap receiving plate 117. Similarly to the case of the housing frame 114, a box-like ink receiving portion 117e is formed at a right end of the cap receiving plate 117, and two groove portions 117f which are semicircular notches are formed in a top surface of the ink receiving portion 117e and may receive the ink inflow tubes 116d.

Therefore, when the two manifolds 116a and 116b are sandwiched by the housing frame 114 and the cap receiving plate 117 from above and from below, respectively, and a first engaging portion 117b, a second engaging portion 117c, and a third engaging portion 117d are engaged with bottom surfaces of the manifolds 116a and 116b, the ink inflow tubes 116d of the manifolds 116a and 116b are sandwiched and fixed by the groove portion 114u formed in the top surface of the communicating portion 114s of the housing frame 114 and the groove portions 117f formed in the top surface of the ink receiving portion 117e of the cap receiving plate 117, and the top surface of the communicating portion 114s of the housing frame 114 and the top surface of the ink receiving portion 117e of the cap receiving plate 117 are brought into contact with each other to form space for storing ink. As a result, ink which flows in from the ink flow path is stored in the space formed by the communicating portion 114s and the ink receiving portion 117e, and may be divided and supplied to the two manifolds 116a and 116b. Japanese Patent Application Laid-open No. 2004-90492 describes simplification of a structure for supplying ink to ink flow paths which are formed on both sides of a head chip.

Japanese Patent Application Laid-open No. 2007-50687 describes an ink jet head for discharging ink from grooves which are formed on both sides of a head chip block (see, for example, FIG. 7 of Japanese Patent Application Laid-open No. 2007-50687). The ink jet head includes a head chip block which is formed by stacking piezoelectric plates having many grooves for discharging ink formed in a surface thereof under a state in which the grooves are on outer surfaces, ink chamber plates for supplying ink to the grooves which are formed on both sides of the head chip block, an ink flow path member for supplying ink to one of the ink chamber plates, and the like. One of the ink chamber plates which is placed on one side of the head chip block and the other of the ink chamber plates which is placed on the other side of the head chip block communicate to each other via an ink hole which is formed so as to pierce the two piezoelectric plates. Therefore, ink which is supplied from the outside may flow in the ink chamber plate on the one side via the ink flow path member which is placed on the one side, and further, may flow in the ink chamber plate on the other side via the ink hole. This structure may make the ink jet head more compact and more lightweight, and further, may decrease the number of parts.

Japanese Patent Application Laid-open No. Hei 8-174819 describes an ink jet head having two nozzle columns (see, for example, FIG. 2 of Japanese Patent Application Laid-open No. Hei 8-174819). The ink jet head includes a substrate having a plurality of piezoelectric elements arranged in two columns, a frame member for housing the piezoelectric elements, a vibration plate having a diaphragm formed therein at a location corresponding to the piezoelectric elements, a liquid chamber flow path forming member for forming a flow path of ink, and a nozzle plate having the two nozzle columns formed therein, which are stacked and bonded to one another. The diaphragm is capable of propagating vibrations from the piezoelectric elements, and pressurizing chambers filled with ink are placed thereon. When a drive signal is applied to a piezoelectric element, the diaphragm vibrates to pressurize ink in a pressurizing chamber over the piezoelectric element to cause ink to be discharged from a nozzle which communicates to the pressurizing chamber.

In the liquid chamber flow path forming member, a common liquid chamber “a” having an outside common liquid chamber and an inside common liquid chamber arranged side by side and a common liquid chamber “b” structured in the same way are formed so as to be side by side. The common liquid chambers “a” and “b” correspond to the two nozzle columns arranged side by side, respectively. Each of the common liquid chambers “a” and “b” includes a plurality of pressurizing chambers formed in a line at a center position between the outside common liquid chamber and the inside common liquid chamber. Each of the pressurizing chambers communicates to both the outside common liquid chamber and the inside common liquid chamber which are arranged on both sides thereof, and is formed to be capable of being supplied with ink by the two common liquid chambers. The pressurizing chambers communicate to corresponding nozzles in the corresponding nozzle columns, respectively. Therefore, ink is supplied to a pressurizing chamber from both the outside common liquid chamber and the inside common liquid chamber, and further, is supplied to a corresponding nozzle. The common liquid chambers “a” and “b” are supplied with ink by an ink supply hole formed at one ends of the common liquid chambers “a” and “b” and midway between the common liquid chambers “a” and “b”. This structure enables simultaneous distributed supply of ink to the pressurizing chambers.

However, in the ink jet head described in Japanese Patent Application Laid-open No. 2004-90492, the communicating portion 114s and the ink receiving portion 117e for dividing and supplying ink to the manifolds 116a and 116b are separated into the housing frame 114 side and the cap receiving plate 117 side. The ink inflow tubes 116d for causing ink to flow in the manifolds 116a and 116b are sandwiched in a groove formed in the square-like communicating portion 114s of the housing frame 114 and a groove formed in the square-like ink receiving portion 117e of the cap receiving plate 117, the communicating portion 114s and the ink receiving portion 117e being bonded to each other. Therefore, the two parts of the communicating portion 114s and the ink receiving portion 117e and a bonding step of bonding the two parts are necessary, and further, there is a possibility that ink leaks from the bonding portion.

Further, the depth and the width in a direction of a short side of the supply recess portion 116c formed in the manifolds 116a and 116b are constant with respect to a direction of a long side. More specifically, a cross-sectional area of the supply recess portion 116c in a direction orthogonal to the direction of the long side is constant from the ink inflow tube 116d side to an ink outflow tube 116e side. However, ink in the supply recess portion 116c is discharged and consumed in driving. For example, suppose ink is discharged from all nozzles in one column. Ink is consumed on the way from the ink inflow tube 116d side to the ink flow tube 116e side, and pressure of the ink is reduced. Therefore, discharge speed of a liquid droplet discharged from a nozzle becomes higher on the ink inflow tube 116d side and lower as the distance to the ink inflow tube 116d becomes larger. There is a distance between the nozzles and a recording medium, and in addition, the recording medium moves with respect to the nozzles. Therefore, unevenness of the discharge speed of a liquid droplet results in unevenness of the place at which a liquid droplet performs recording, and thus, there is a problem in that the positional precision of a liquid droplet is lowered.

Further, in the ink jet head described in Japanese Patent Application Laid-open No. 2007-50687, ink flows in from the ink flow path member which is placed on the one side of the head chip block to be supplied to the grooves in an actuator on the one side. Ink is supplied to an actuator on the other side via the ink hole. More specifically, ink flow paths of ink to be supplied are not symmetrical between the one side and the other side. Therefore, there is a difference between the one side and the other side in the discharge speed of a liquid droplet discharged from a nozzle due to flow path resistance in the ink hole and the like, and thus, there is a problem in that the positional precision of a liquid droplet which performs recording is lowered.

Further, in the ink jet head described in Japanese Patent Application Laid-open No. Hei 8-174819, cross-sectional areas of flow paths in the common liquid chamber “a” and in the common liquid chamber “b” in the direction orthogonal to the nozzle columns are constant from a side nearer to the ink supply hole to a side farther to the ink supply hole. Therefore, discharge speed of a liquid droplet discharged from a nozzle becomes higher at a place nearer to the ink supply hole and becomes lower at a place farther to the ink supply hole. Therefore, the discharge speed of a liquid droplet is uneven, and thus, there is a problem in that the positional precision of a liquid droplet which lands on a recording medium is lowered.

### SUMMARY OF THE INVENTION

A liquid jet head according to the present invention includes: an actuator chip including a first actuator and a second actuator, the first actuator including a plurality of grooves arranged in a direction of a long side on one surface side of a substrate and a nozzle column of nozzle holes arranged in the direction of the long side, the nozzle holes communicating to the plurality of grooves, respectively, the second actuator including a plurality of grooves arranged in the direction of the long side on another surface side of the substrate and a nozzle column of nozzle holes arranged in the direction of the long side, the nozzle holes communicating to the plurality of grooves, respectively; a first flow path member including a first liquid supply chamber for supplying liquid to the plurality of grooves arranged on the one surface side and a first inflow hole for causing liquid to flow in the first liquid supply chamber; a second flow path member including a second liquid supply chamber for supplying liquid to the plurality of grooves arranged on the another surface side and a second inflow hole for causing liquid to flow in the second liquid supply chamber; and a connecting member which has a flow path formed therein and which is connected to the first flow path member and the second flow path member, for dividing and supplying liquid to the first inflow hole and the second inflow hole, in which: each of the first liquid supply chamber and the second liquid supply chamber is formed of an elongated region which corresponds to the plurality of grooves arranged in the direction of the long side and which extends in the direction of the long side; each of the first inflow hole and the second inflow hole is open at one end of the elongated region; and the elongated region has a cross-sectional area in a direction orthogonal to the direction of the long side which gradually decreases from the one end to another end which is on an opposite side of the one end.

Further, in the liquid jet head according to the present invention, the first flow path member and the second flow path member include protruding inflow tubes which communicate to the first inflow hole and the second inflow hole, respectively, and the connecting member includes a first outflow hole and a second outflow hole which fit on the protruding inflow tubes, respectively.

Further, in the liquid jet head according to the present invention, the connecting member includes a liquid inflow portion for causing liquid to flow in, and the liquid inflow portion includes an opening for receiving a supply tube for supplying liquid and a step portion formed on inside of the opening which is, when the supply tube is inserted therein, brought into abutting contact with the supply tube.

Further, in the liquid jet head according to the present invention, the flow path in the connecting member is bent, and an outer peripheral side of the flow path which is bent includes a curved surface.

Further, in the liquid jet head according to the present invention, in which the flow path in the connecting member includes a splitting portion for splitting liquid, and the splitting portion includes a surface which is a convex curved surface.

Further, the liquid jet head according to the present invention further includes: a pressure buffer including a supply tube for supplying liquid to the connecting member, in which the supply tube has an O-ring receiving groove in an outer peripheral portion near a tip thereof, and the supply tube with an O ring placed in the O-ring receiving groove is attached to an opening of the connecting member.

A liquid jet apparatus according to the present invention includes: any one of the above-mentioned liquid jet heads; transfer means for transferring a recording medium in a main scan direction; a liquid tank for storing liquid; a pump for pressing liquid from the liquid tank into the any one of the above-mentioned liquid jet heads for supply; and a moving mechanism for causing the any one of the above-mentioned liquid jet heads to move in an auxiliary scan direction which is orthogonal to the main scan direction.

The liquid jet head according to the present invention includes: the actuator chip including the first actuator and the second actuator, the first actuator including the plurality of grooves arranged in the direction of the long side on the one surface side of the substrate and the nozzle column of the nozzle holes arranged in the direction of the long side, the nozzle holes communicating to the plurality of grooves, respectively, the second actuator including the plurality of grooves arranged in the direction of the long side on the another surface side of the substrate and the nozzle column of the nozzle holes arranged in the direction of the long side, the nozzle holes communicating to the plurality of grooves, respectively; the first flow path member including the first liquid supply chamber for supplying liquid to the plurality of grooves arranged on the one surface side and the first inflow hole for causing liquid to flow in the first liquid supply chamber; the second flow path member including the second liquid supply chamber for supplying liquid to the plurality of grooves arranged on the another surface side and the second inflow hole for causing liquid to flow in the second liquid supply chamber; and the connecting member which has the flow path formed therein and which is connected to the first flow path member and the second flow path member, for dividing and supplying liquid to the first inflow hole and the second inflow hole, in which each of the first liquid supply chamber and the second liquid supply chamber is formed of the elongated region which corresponds to the plurality of grooves arranged in the direction of the long side; each of the first inflow hole and the second inflow hole is open at the one end of the elongated region; and the elongated region has the cross-sectional area in the direction orthogonal to the direction of the long side which gradually decreases from the one end to the another end which is on the opposite side of the one end. As described above, the connecting member is connected to the end of the first flow path member and the end of the second flow path member in the direction of the long side, and thus, the thickness of the liquid jet head may be made smaller, and liquid may be evenly divided and supplied to the first liquid supply chamber and the second liquid supply chamber. Further, the cross-sectional areas of the first liquid supply chamber and the second liquid supply chamber in the direction orthogonal to the direction of the long side are formed to gradually decrease from the inflow hole side to the side opposite thereto, and thus, unevenness of the speed of a liquid droplet jetted from the respective nozzles may be reduced, and the positional precision of a landing point of a liquid droplet, which lands on a recording medium, may be improved.

### BRIEF DESCRIPTION OF THE DRAWINGS

In the accompanying drawings:

FIGS. 1A to 1D are explanatory views of a liquid jet head according to a first embodiment of the present invention;

FIGS. 2A to 2C are explanatory views of a liquid jet head according to a second embodiment of the present invention;

FIGS. 3A and 3B are explanatory views of a liquid jet head according to a third embodiment of the present invention;

FIG. 4 is an exploded perspective view of a liquid jet head according to a fourth embodiment of the present invention;

FIG. 5 is a schematic perspective view of a liquid jet apparatus according to a fifth embodiment of the present invention; and

FIGS. 6A to 6C are explanatory views of manifolds applied to a conventionally known ink jet head.

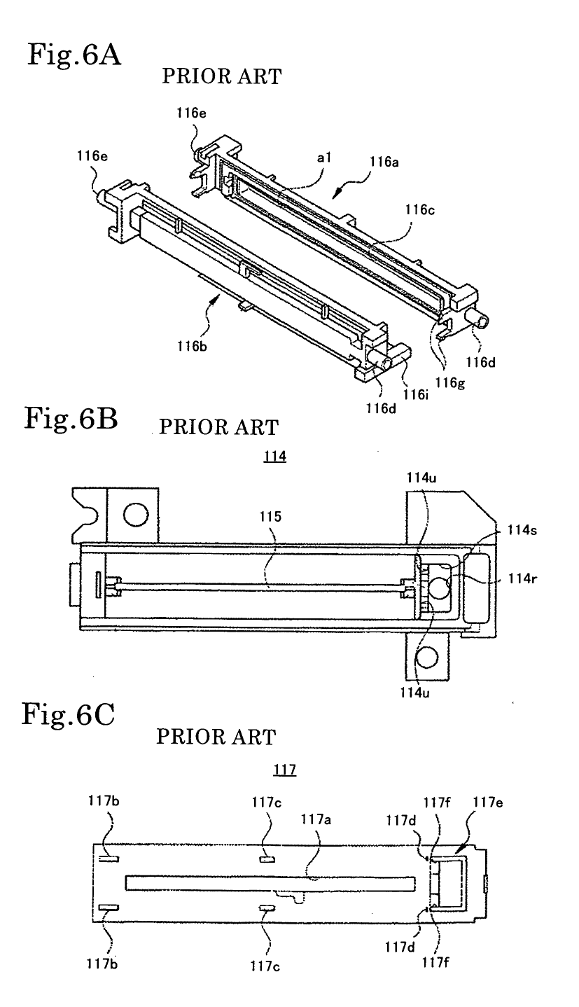

### DETAILED DESCRIPTION OF THE PREFERRED EMBODIMENTS

A liquid jet head according to the present invention includes an actuator chip having a first actuator on one surface side of an elongated substrate and a second actuator on the other surface side which is different from the one surface side, a first flow path member for supplying liquid to the first actuator, a second flow path member for supplying liquid to the second actuator, and a connecting member for dividing and supplying liquid to the first flow path member and the second flow path member.

The first actuator includes a plurality of grooves formed on the one surface side of the substrate, and the plurality of grooves are arranged in a direction of a long side of the substrate. The first actuator further includes nozzle holes which communicate to the grooves, respectively, and which are arranged, for example, in the direction of the long side of an end surface of the substrate. The second actuator includes a plurality of grooves formed on the other surface side of the substrate which is different from the one surface side, and the plurality of grooves are arranged in the direction of the long side of the substrate. The second actuator further includes nozzle holes which communicate to the grooves, respectively, and which are arranged, for example, in the direction of the long side of the end surface of the substrate. The first flow path member includes a first liquid supply chamber for supplying liquid to the plurality of grooves in the first actuator and a first inflow hole for causing liquid to flow in the first liquid supply chamber. Similarly, the second flow path member includes a second liquid supply chamber for supplying liquid to the plurality of grooves in the second actuator and a second inflow hole for causing liquid to flow in the second liquid supply chamber. The connecting member is connected to the first flow path member and the second flow path member for dividing and supplying liquid to the first inflow hole and the second inflow hole.

Each of the first liquid supply chamber and the second liquid supply chamber is an elongated region which corresponds to the plurality of grooves arranged in the direction of the long side of the substrate and which extends in the same direction as the direction of the long side of the substrate. The first inflow hole or the second inflow hole is open at one end of the elongated region. The elongated regions of the first liquid supply chamber and the second liquid supply chamber are narrowed so that the cross-sectional areas thereof in the direction orthogonal to the direction of the long side gradually decrease from an end on the first inflow hole side or the second inflow hole side to the other end which is on the opposite side.

The liquid jet head has a structure in which the first flow path member, the actuator chip, and the second flow path member are stacked. Therefore, by placing the connecting member at one ends of the first flow path member and the second flow path member, in other words, at an end of the above-mentioned stacked structure, the thickness of the liquid jet head as a whole may be made smaller.

By placing the connecting member at the end of the above-mentioned stacked structure, liquid may be divided and supplied to the first flow path member and the second flow path member under equal conditions, for example, with equal flow path resistance and equal liquid pressure. Further, the cross-sectional areas of the first liquid supply chamber and the second liquid supply chamber in the direction orthogonal to the direction of the long side are formed to gradually decrease from the inflow hole side to the opposite side thereof, and thus, even when liquid is discharged from the respective nozzles to be consumed, liquid pressures in the first liquid supply chamber and in the second liquid supply chamber may be made constant and liquid may be supplied to the respective grooves in the first actuator and the second actuator under substantially equal pressure. Therefore, unevenness of discharge speed of a liquid droplet discharged from the respective nozzles may be reduced, and the positional precision of a landing point of a liquid droplet, which lands on a recording medium, may be improved.

Note that, as the first actuator and the second actuator, a piezoelectric wafer made of lead zirconate titanate (PZT) ceramic or the like may be used. By forming a plurality of grooves in surfaces of the two piezoelectric wafers and providing liquid supply holes for supplying liquid to the plurality of grooves, the first actuator and the second actuator are formed. By bonding the two actuators under a state in which surfaces having the grooves formed therein are outer surfaces, the actuator chip may be formed. Alternatively, by forming a plurality of grooves in both surfaces of one piezoelectric wafer and providing liquid supply holes for supplying liquid to the respective grooves, the actuator chip having the first actuator and the second actuator may be formed.

As the first flow path member, the second flow path member, and the connecting member, a synthetic resin or a metallic material may be used. Each of the first liquid supply chamber and the second liquid supply chamber formed in the first flow path member and the second flow path member, respectively, may be one elongated region or a plurality of separate regions. When each of the first liquid supply chamber and the second liquid supply chamber is an elongated region formed of one recess portion, the width of the recess portion may be formed to gradually decrease from an end thereof to the other end thereof, or, the depth of the recess portion may be formed to gradually decrease from an end thereof to the other end thereof.

Further, the first flow path member and the second flow path member may include a protruding first inflow tube and a protruding second inflow tube which communicate to the inflow holes, respectively, and the connecting member may include a first outflow hole and a second outflow hole which fit on the first inflow tube and the second inflow tube, respectively. This eliminates the necessity of sandwiching the first inflow tube and the second inflow tube between divided connecting members and bonding the first inflow tube and the second inflow tube to the divided connecting members, and the first flow path member and the second flow path member may be connected to the connecting member by inserting the first inflow tube and the second inflow tube in the first outflow hole and the second outflow hole, respectively, which may simplify the structure and may reduce the man-hours necessary for the assembly.

Further, the connecting member includes a liquid inflow portion for causing liquid to flow in from the outside. The liquid inflow portion includes an opening for inserting a supply tube for supplying liquid. The opening includes a step portion formed on the inside thereof which is, when the supply tube is inserted therein, brought into abutting contact with a tip of the supply tube. By providing the step portion on the inside of the opening, attaching/detaching the supply tube to/from the connecting member become easier, which eases maintenance.

Further, a flow path in the connecting member is bent, and an outer peripheral side of the bent flow path includes a curved surface. Further, the flow path in the connecting member includes a splitting portion for splitting liquid. The splitting portion includes a convex curved surface. By forming the outer peripheral portion of the bent flow path and the surface of the splitting portion for splitting liquid so as to be curved surfaces in this way, a liquid accumulation at which flow of liquid builds up decreases, and the flow path may be cleaned promptly and air bubbles which are trapped in the flow path may be removed promptly.

Further, a pressure buffer may be additionally provided. The pressure buffer includes a supply tube for supplying liquid to the connecting member. The supply tube has an O-ring receiving groove. The supply tube with an O ring placed in the O-ring receiving groove may be attached to an opening of the connecting member. This makes it possible to, even if the supply tube is repeatedly attached to/detached from the opening of the connecting member, maintain hermetic seal between the opening and the supply tube, which may ease maintenance and may improve reliability against leakage of liquid and the like.

The present invention is now described in detail in the following with reference to the attached drawings.

### First Embodiment

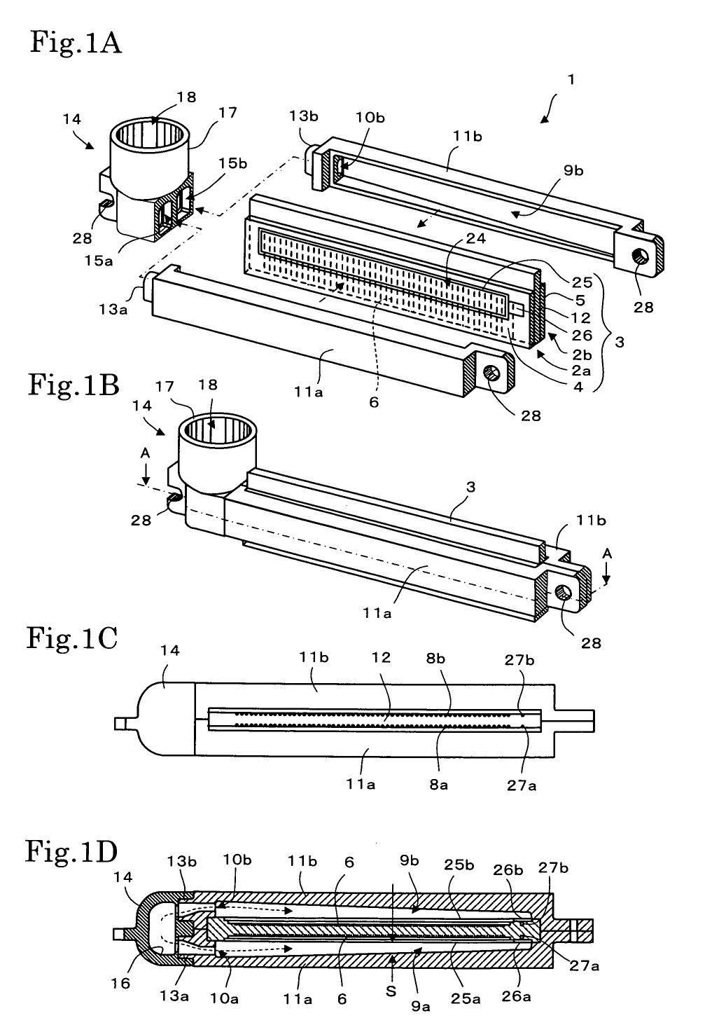

FIGS. 1A to 1D are explanatory views for describing a liquid jet head 1 according to a first embodiment of the present invention. FIG. 1A is an exploded perspective view of the liquid jet head 1, FIG. 1B is a perspective view illustrating an assembled state, FIG. 1C is a bottom view illustrating the assembled state, and FIG. 1D is a transverse sectional view taken along the line A-A of FIG. 1B.

The liquid jet head 1 includes an actuator chip 3 for discharging a liquid droplet, a first flow path member 11a and a second flow path member 11b for sandwiching the actuator chip 3, and a connecting member 14 connected to an end of the first flow path member 11a and an end of the second flow path member 11b. The actuator chip 3 includes a long substrate 12, a first actuator 2a formed on one surface 4 side of the substrate 12 and a second actuator 2b formed on the other surface 5 side of the substrate 12.

The first actuator 2a includes a plurality of grooves 6 formed in a direction of a short side and arranged in a direction of a long side on the one surface 4 side of the substrate 12, a liquid supply hole 24 for guiding liquid to the plurality of grooves 6, and a plurality of first nozzle holes 8a which are open in a lower end surface of the substrate 12 and which communicate to the plurality of grooves 6, respectively. Similarly to the first actuator 2a, the second actuator 2b includes a plurality of grooves formed in the direction of the short side and arranged in the direction of the long side on the other surface 5 side of the substrate 12, a liquid supply hole for guiding liquid to the plurality of grooves, and a plurality of second nozzle holes 8b which are open in the lower end surface of the substrate 12 and which communicate to the plurality of grooves, respectively. Therefore, as illustrated in FIG. 1C, the first nozzle holes 8a and the second nozzle holes 8b are arranged side by side in the direction of the long side in the lower end surface of the substrate 12.

Note that, more specifically, the substrate 12 has a four-layer structure. The first actuator 2a includes a piezoelectric plate having the many grooves 6 formed in a surface thereof and the extending liquid supply hole 24, and further, a cover plate bonded to the grooves 6 side of the piezoelectric plate, a filter 25 placed in the liquid supply hole 24 of the cover plate, and a vent filter 26. The grooves 6 provided in the surface of the piezoelectric plate are exposed in the liquid supply hole 24, and thus, liquid may be supplied from the liquid supply hole 24 to the respective grooves 6. The second actuator 2b has a similar structure. Rear surfaces of the first actuator 2a and the second actuator 2b which are opposite to the surfaces having the grooves 6 formed therein are bonded to each other to form the actuator chip 3.

The first flow path member 11a includes a first liquid supply chamber 9a which is open to the actuator chip 3 side, a first inflow hole 10a for guiding liquid to the first liquid supply chamber 9a, and a first inflow tube 13a which communicates to the first inflow hole 10a. The second flow path member 11b has a structure similar to that of the first flow path member 11a, and includes a second liquid supply chamber 9b which is open to the actuator chip 3 side, a second inflow hole 10b for guiding liquid to the second liquid supply chamber 9b, and a second inflow tube 13b which communicates to the second inflow hole 10b. Here, the first liquid supply chamber 9a and the second liquid supply chamber 9b correspond to the plurality of grooves 6 formed on the one surface 4 side and on the other surface 5 side, respectively, of the actuator chip 3, and are elongated regions. More specifically, the first liquid supply chamber 9a and the second liquid supply chamber 9b correspond to liquid supply holes 24 formed on the one surface 4 side and on the other surface 5 side, respectively, of the actuator chip 3. As illustrated in FIG. 1D, depths d of the first liquid supply chamber 9a and the second liquid supply chamber 9b gradually decrease from ends on the side of the first inflow hole 10a and on the side of the second inflow hole 10b to the other ends, respectively. In other words, the cross-sectional areas in a direction orthogonal to a direction of a long side of the first liquid supply chamber 9a and the second liquid supply chamber 9b gradually decrease from a liquid inflow side to the opposite side.

The connecting member 14 includes a liquid inflow portion 17 for guiding liquid which is provided in an upper portion thereof and a first outflow hole 15a and a second outflow hole 15b which are provided in a side surface in a lower portion thereof. The connecting member 14 has a flow path 16 formed therein, and an opening 18 in the upper portion thereof and the first outflow hole 15a and the second outflow hole 15b in the lower portion thereof communicate to each other. The first inflow tube 13a of the first flow path member 11a is inserted in the first outflow hole 15a in the side surface in the lower portion thereof, and the second inflow tube of the second flow path member 11b is inserted in the second outflow hole 15b, thereby attaching and fixing the flow path member 11a and the flow path member 11b. The flow path 16 in the connecting member 14 is shaped so as to be symmetrical with respect to a vertical plane located midway between the first outflow hole 15a and the second outflow hole 15b. Therefore, the flow path resistance and the pressure of liquid which flows out to the first flow path member 11a are equal to the flow path resistance and the pressure of liquid which flows out to the second flow path member 11b.

Liquid guided from the liquid inflow portion 17 is divided and flows via the first inflow tube 13a and the second inflow tube 13b in the first flow path member 11a and the second flow path member 11b, respectively. Further, liquid flows from the first flow path member 11a and the second flow path member 11b in the grooves 6 in the first actuator 2a and the second actuator 2b, and, based on a drive signal applied to the actuator chip 3, is discharged from the first nozzle holes 8a and the second nozzle holes 8b, respectively.

The connecting member 14 is placed at the ends of the first flow path member 11a and the second flow path member 11b and at an end of the actuator chip 3 in this way, and thus, the thickness of the liquid jet head 1 as a whole may be made smaller. Further, liquid may be divided and supplied to the first flow path member 11a and the second flow path member 11b with equal flow path resistance and equally applied pressure. Still further, cross-sectional areas S in the direction orthogonal to the direction of the long side of the first liquid supply chamber 9a and the second liquid supply chamber 9b gradually decrease from the ends on the side of the first inflow hole 10a and on the side of the second inflow hole 10b to the other ends thereof, respectively, and thus, unevenness of speed of a liquid droplet jetted from the respective nozzles may be reduced, and the positional precision of a landing point of a liquid droplet, which lands on a recording medium, may be improved.

Note that, a step portion for placing a filter is provided on the periphery of the liquid supply hole 24 formed in a surface of the first actuator 2a, and a first filter 25a is placed thereon. Similarly, a second filter 25b is placed on a surface of the second actuator 2b. Further, vent filters 26a and 26b for removing air bubbles which are trapped in the flow paths are placed on the surfaces of the first actuator 2a and the second actuator 2b at an end of the first flow path member 11a and at an end of the second flow path member 11b which are opposite to the side of the first inflow hole 10a and the second inflow hole 10b, and vent grooves 27a and 27b are formed at corresponding places, respectively. By placing the first filter 25a and the second filter 25b, a malfunction that the first nozzle holes 8a and the second nozzle holes 8b are clogged with air bubbles may be reduced. Further, when air bubbles are trapped in liquid, the air bubbles may be discharged promptly to the outside via the vent grooves 27a and 27b.

Further, the vent filters 26a and 26b are placed on the upper portions of the vent grooves 27a and 27b, respectively, and thus, gas may be prevented from entering the first liquid supply chamber 9a and the second liquid supply chamber 9b via the vent grooves 27a and 27b. Further, through holes 28 for fastening with screws to a frame (not shown) are formed at the other ends of the first flow path member 11a and the second flow path member 11b and on a side surface of the connecting member 14.

### Second Embodiment

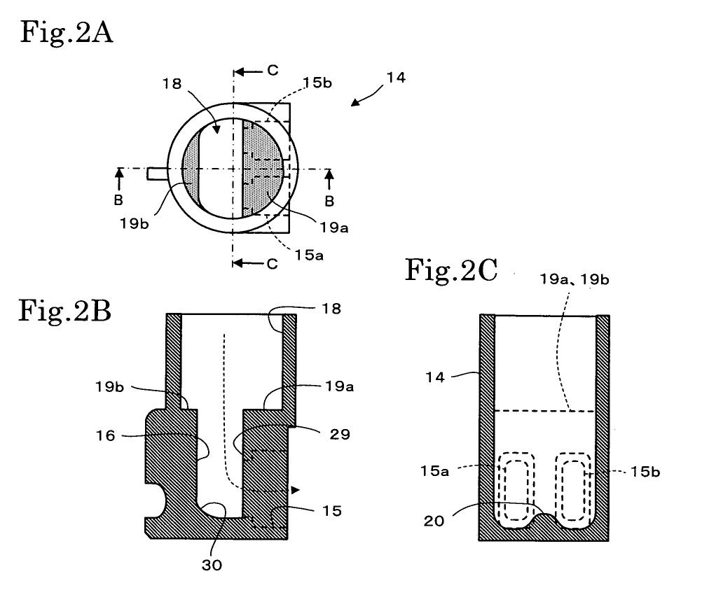

FIGS. 2A to 2C are explanatory views of a connecting member 14 of a liquid jet head 1 according to a second embodiment of the present invention. FIG. 2A is a top view of the connecting member 14, FIG. 2B is a longitudinal sectional view taken along the line B-B of FIG. 2A, and FIG. 2C is a longitudinal sectional view taken along the line C-C of FIG. 2A. In the second embodiment, an actuator chip 3 and a first flow path member 11a and a second flow path member 11b are similar to those in the first embodiment, and thus, description thereof is omitted. Note that, like reference numerals are used to designate like members or members having like functions.

The connecting member 14 includes a cylindrical opening 18 in an upper portion thereof for guiding liquid and the first outflow hole 15a and the second outflow hole 15b in a lower portion thereof for inserting the first inflow tube 13a and the second inflow tube 13b, respectively. As illustrated in FIG. 2B, the connecting member 14 has, in the opening 18, a first step portion 19a and a second step portion 19b the heights of which are approximately ½ of the height of the connecting member 14 and which extend from a cylindrical inner wall surface toward a central axis of the cylinder. Top surfaces of the first step portion 19a and the second step portion 19b are substantially in the shape of a crescent the chords of which are shorter than the inside diameter of the opening 18, and the area of the top surface of the first step portion 19a is larger than that of the second step portion 19b. A side surface 29 of the first step portion 19a is a flat surface, and the first outflow hole 15a and the second outflow hole 15b are open to the flat side surface 29. There are curved surfaces between a side surface of the second step portion 19b and the cylindrical inner wall surface. Further, a bent outer peripheral surface 30 between the side surface of the second step portion 19b and an inner surface at the bottom is formed so as to be a curved surface. The bent outer peripheral surface 30 is on an outer peripheral side of a bent flow path 16. Further, as illustrated in FIG. 2C, the flow path 16 in the connecting member 14 includes a splitting portion 20 at the bottom. The splitting portion 20 is located in front of the openings of the first outflow hole 15a and the second outflow hole 15b between the first outflow hole 15a and the second outflow hole 15b. The splitting portion 20 is formed so as to have a curved convex surface.

By forming the first step portion 19a and the second step portion 19b in this way, when a supply tube is inserted in the opening 18, a tip of the supply tube is brought into abutting contact with the first step portion 19a or the second step portion 19b. Therefore, even if the supply tube is repeatedly attached/detached, difficulty in disconnection is less liable to occur, which may ease maintenance. Further, the bent outer peripheral surface 30 and the surface of the splitting portion 20 are curved, and thus, a liquid accumulation at which flow of liquid builds up decreases, and air bubbles and dust which are trapped in the liquid may be removed promptly. Further, the inside shape of the connecting member 14 is formed to decrease the inside diameter thereof from the upper portion to the lower portion thereof and the first outflow hole 15a and the second outflow hole 15b provided at the bottom are formed to be open to the flat side surface of the first step portion 19a, and thus, the connecting member 14 may be integrally molded with ease. Therefore, the number of parts may be decreased and the man-hours necessary for the assembly may be reduced.

### Third Embodiment

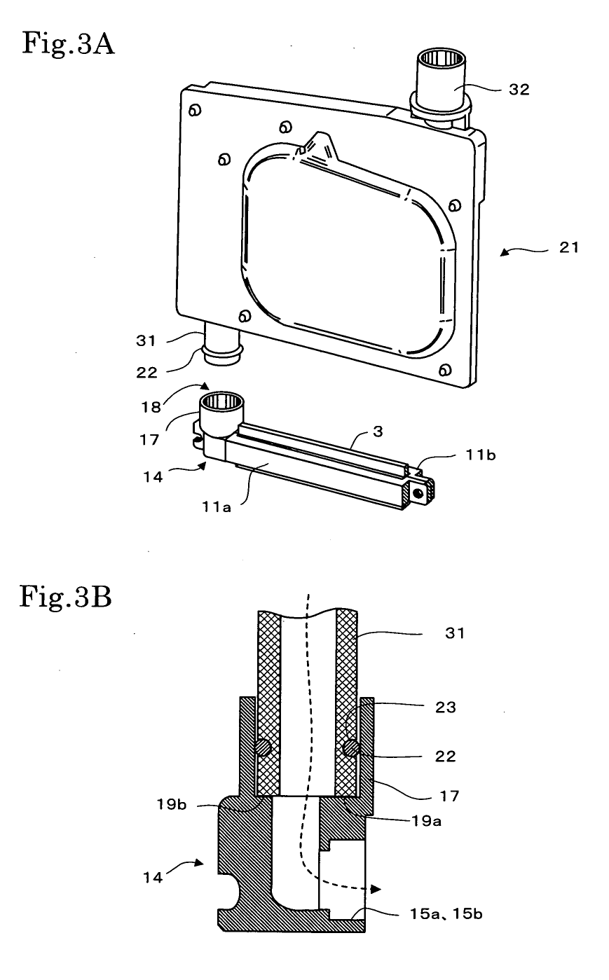

FIGS. 3A and 3B are explanatory views of a liquid jet head 1 according to a third embodiment of the present invention. FIG. 3A is an exploded perspective view with a pressure buffer 21 detached from a connecting member 14, and FIG. 3B is a schematic longitudinal sectional view of a connecting member 14. The connecting member 14 has a structure which is similar to that in the above-mentioned second embodiment.

When the liquid jet head 1 moves, a shock wave due to inertia is applied to liquid in a liquid supply tube. Pressure fluctuations caused by the shock wave change discharge speed of a liquid droplet discharged from a nozzle. The pressure buffer 21 is provided for the purpose of absorbing the pressure fluctuations and maintaining the discharge speed of a liquid droplet at a constant level. Liquid flows in from a connecting tube 32 and is supplied to the liquid jet head 1 from a supply tube 31. An O-ring receiving groove 23 is formed at a tip of the supply tube 31, and an O ring 22 is fitted in the O-ring receiving groove 23.

When the supply tube 31 is inserted in an opening 18 of a liquid inflow portion 17, the O ring 22 is brought into contact with an inner wall surface of the opening 18, and liquid inside is sealed in against leakage to the outside. A first step portion 19a and a second step portion 19b are provided in the opening 18, and thus, the tip of the supply tube 31 is brought into abutting contact with the step portions 19a and 19b. Therefore, even if the supply tube 31 is repeatedly attached to/detached from the opening 18 of the connecting member 14, hermetic seal may be maintained between the opening 18 and the supply tube 31, which may ease maintenance and may improve reliability against leakage of liquid and the like. The structure of the connecting member 14 with regard to other points and the first flow path member 11a, the second flow path member 11b, and the actuator chip 3 are similar to those in the first embodiment or in the second embodiment, and thus, description thereof is omitted.

Note that, in this embodiment, a case in which the supply tube 31 attached to the pressure buffer 21 is inserted in the opening 18 is described, but the present invention is not limited thereto. The pressure buffer 21 may be omitted, the O ring 22 may be attached to the supply tube 31 having the O-ring receiving groove 23 formed therein, and the supply tube 31 may be inserted in the opening 18.

### Fourth Embodiment

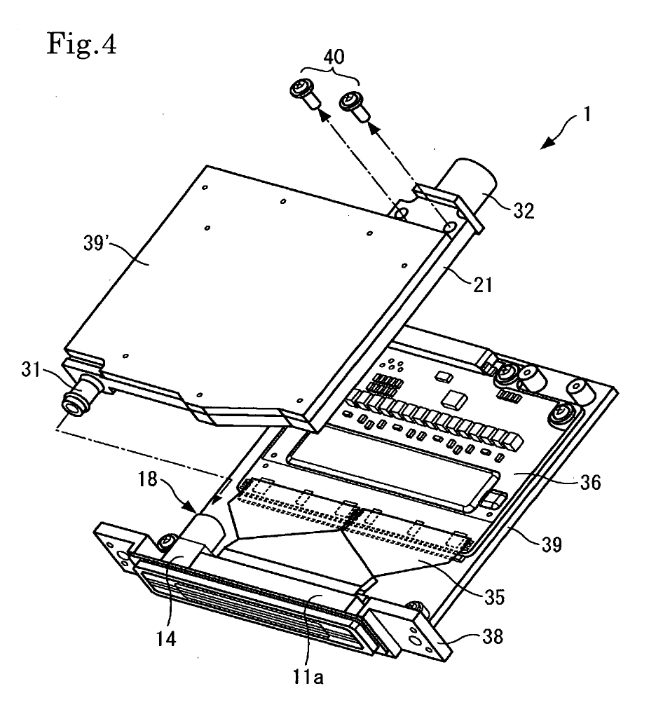

FIG. 4 is a schematic exploded perspective view of a liquid jet head 1 according to a fourth embodiment of the present invention. A base 38 supports a connecting member 14, a first flow path member 11a and a second flow path member 11b, and covers 39 and 39′. The cover 39 on a rear side houses a circuit substrate 36 having thereon a drive control circuit for jetting liquid from nozzle holes. One end of a flexible printed circuit (FPC) board 35 is connected to an upper end of an actuator chip 3 while the other end thereof is connected to a lower end of the circuit substrate 36. The FPC board 35 propagates a drive signal. A pressure buffer 21 is placed on a top surface of the circuit substrate 36, and an upper portion of the pressure buffer 21 is fastened to the cover 39 on the rear side with screws 40. A supply tube 31 of the pressure buffer 21 is inserted in an opening 18 of a connecting member 14 to be coupled. The cover 39′ on a front side is placed on a top surface of the pressure buffer 21 to protect the pressure buffer 21.

Here, the connecting member 14, the first flow path member 11a, and the second flow path member 11b have structures which are similar to those in the first embodiment or in the second embodiment. The connecting member 14 is placed at the ends of the first flow path member 11a and the second flow path member 11b and at the end of the actuator chip 3 and the plate-like pressure buffer 21 and the circuit substrate 36 are formed to be stacked in this way, and thus, the thickness of the liquid jet head 1 may be made smaller, and liquid may be supplied to the first flow path member 11a and the second flow path member 11b under equal conditions. Further, if the cross-sectional areas of the first liquid supply chamber and the second liquid supply chamber in the direction orthogonal to the direction of the long side are formed to gradually decrease from the inflow hole side to the opposite side thereof, even when fluid is discharged from the respective nozzles to be consumed, liquid pressures in the first liquid supply chamber and the second liquid supply chamber may be made constant and liquid may be supplied to the respective grooves in the first actuator and the second actuator under substantially equal pressure. Therefore, unevenness of discharge speed of a liquid droplet discharged from the respective nozzles may be reduced, and the positional precision of a landing point of a liquid droplet, which lands on a recording medium, may be improved.

Further, if a first step portion and a second step portion are formed in the opening 18 of the connecting member 14, when the supply tube 31 is inserted in the opening 18, a tip of the supply tube 31 is brought into abutting contact with the first step portion or the second step portion. Therefore, even if the supply tube 31 is repeatedly attached/detached, difficulty in disconnection is less liable to occur, which may ease maintenance. Further, if a bent outer peripheral surface and a splitting portion which are curved surfaces are formed in a flow path in the connecting member 14, a liquid accumulation at which flow of liquid builds up decreases, and air bubbles and dust which are trapped in the liquid may be removed promptly. Further, the connecting member 14 may be integrally molded with ease, and thus, the number of parts may be decreased and the man-hours necessary for the assembly may be reduced.

### Fifth Embodiment

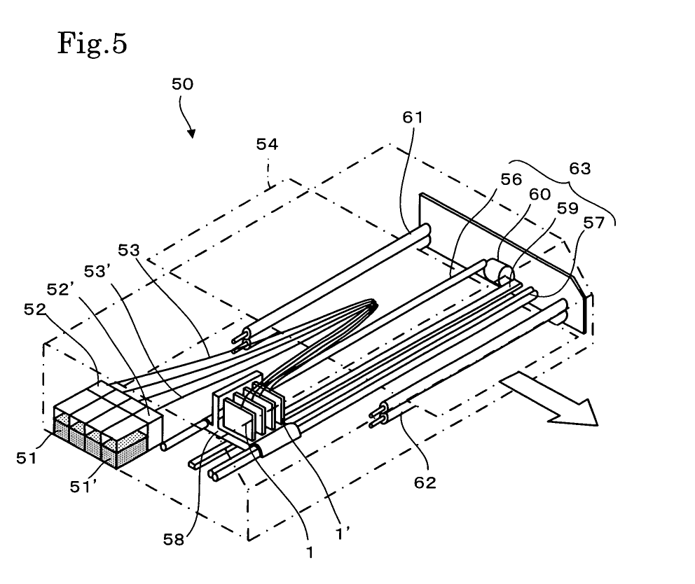

FIG. 5 is a schematic perspective view of a liquid jet apparatus 50 according to a fifth embodiment of the present invention. The liquid jet apparatus 50 uses any one of the liquid jet heads 1 described in the above-mentioned first to fourth embodiments. The liquid jet apparatus 50 includes a moving mechanism 63 for reciprocating liquid jet heads 1 and 1′, liquid supply tubes 53 and 53′ for supplying liquid to the liquid jet heads 1 and 1′, and liquid tanks 51 and 51′ for supplying liquid to the liquid supply tubes 53 and 53′. Each of the liquid jet heads 1 and 1′ includes an actuator chip for causing liquid to be discharged, a first flow path member and a second flow path member for supplying liquid to the actuator chip, a connecting member for dividing and supplying liquid to the first flow path member and the second flow path member, and a pressure buffer for supplying liquid to the connecting member liquid with pressure fluctuations of the liquid being absorbed.

Specific description is made in the following. The liquid jet apparatus 50 includes a pair of transfer means 61 and 62 for transferring a recording medium 54 such as paper in a main scan direction, the liquid jet heads 1 and 1′ for discharging liquid toward the recording medium 54, pumps 52 and 52′ for pressing liquid stored in liquid tanks 51 and 51′ into the liquid supply tubes 53 and 53′ for supply, and the moving mechanism 63 for causing the liquid jet heads 1 and 1′ to scan in an auxiliary scan direction which is orthogonal to the main scan direction.

Each of the pair of transfer means 61 and 62 includes a grid roller and a pinch roller which extend in the auxiliary scan direction and which rotate with roller surfaces thereof being in contact with each other. A motor (not shown) axially rotates the grid rollers and the pinch rollers to transfer, in the main scan direction, the recording medium 54 sandwiched therebetween. The moving mechanism 63 includes a pair of guide rails 56 and 57 which extend in the auxiliary scan direction, a carriage unit 58 which is slidable along the pair of guide rails 56 and 57, an endless belt 59 which is coupled to the carriage unit 58, for moving the carriage unit 58 in the auxiliary scan direction, and a motor 60 for rotating the endless belt 59 via a pulley (not shown).

The carriage unit 58 has the plurality of liquid jet heads 1 and 1′ mounted thereon for discharging, for example, four kinds of liquid droplets: yellow; magenta; cyan; and black. The liquid tanks 51 and 51′ store liquid of corresponding colors, and supply the liquid via the pumps 52 and 52′ and the liquid supply tubes 53 and 53′ to the liquid jet heads 1 and 1′. The respective liquid jet heads 1 and 1′ discharge liquid droplets of the respective colors according to a drive signal. By controlling discharge timing of liquid from the liquid jet heads 1 and 1′, rotation of the motor 60 for driving the carriage unit 58, and transfer speed of the recording medium 54, an arbitrary pattern may be recorded on the recording medium 54.

Note that, in the above description, the liquid jet head 1 has a structure in which the first flow path member 11a and the second flow path member 11b sandwich the actuator chip 3 including the first actuator 2a and the second actuator 2b and the connecting member 14 is placed at the end thereof, but the present invention is not limited thereto. The structure may be that many liquid jet heads which are any ones of the liquid jet heads 1 described in the first to fourth embodiments are stacked. Further, many structures in each of which the first flow path member 11a and the second flow path member 11b sandwich the actuator chip 3 may be stacked and a common connecting member 14 may supply liquid to the respective flow path members 11.

What is claimed is:

1. A liquid jet head, comprising:
an actuator chip comprising a first actuator and a second actuator, the first actuator including a plurality of grooves arranged in a direction of a long side on one surface side of a substrate and a nozzle column of nozzle holes arranged in the direction of the long side, the nozzle holes communicating to the plurality of grooves, respectively, the second actuator including a plurality of grooves arranged in the direction of the long side on another surface side of the substrate and a nozzle column of nozzle holes arranged in the direction of the long side, the nozzle holes communicating to the plurality of grooves, respectively;
a first flow path member comprising a first liquid supply chamber for supplying liquid to the plurality of grooves arranged on the one surface side and a first inflow hole for causing liquid to flow in the first liquid supply chamber;
a second flow path member comprising a second liquid supply chamber for supplying liquid to the plurality of grooves arranged on the another surface side and a second inflow hole for causing liquid to flow in the second liquid supply chamber; and
a connecting member which has a flow path formed therein and which is connected to the first flow path member and the second flow path member, for dividing and supplying liquid to the first inflow hole and the second inflow hole, wherein:
each of the first liquid supply chamber and the second liquid supply chamber is formed of an elongated region which corresponds to the plurality of grooves arranged in the direction of the long side and which extends in the direction of the long side;
each of the first inflow hole and the second inflow hole is open at one end of the elongated region; and
the elongated region has a cross-sectional area in a direction orthogonal to the direction of the long side which gradually decreases from the one end to another end which is on an opposite side of the one end.

2. A liquid jet head according to claim 1, wherein:
the first flow path member and the second flow path member comprise protruding inflow tubes which communicate to the first inflow hole and the second inflow hole, respectively; and
the connecting member comprises a first outflow hole and a second outflow hole which fit on the protruding inflow tubes, respectively.

3. A liquid jet head according to claim 1, wherein:
the connecting member comprises a liquid inflow portion for causing liquid to flow in; and
the liquid inflow portion includes an opening for receiving a supply tube for supplying liquid and a step portion formed on inside of the opening which is, when the supply tube is inserted therein, brought into abutting contact with the supply tube.

4. A liquid jet head according to claim 1, wherein:
the flow path in the connecting member is bent; and
an outer peripheral side of the flow path which is bent includes a curved surface.

5. A liquid jet head according to claim 1, wherein:
the flow path in the connecting member includes a splitting portion for splitting liquid; and
the splitting portion includes a surface which is a convex curved surface.

6. A liquid jet head according to claim 1, further comprising a pressure buffer including a supply tube for supplying liquid to the connecting member, wherein:
the supply tube has an O-ring receiving groove in an outer peripheral portion near a tip thereof; and
the supply tube with an O ring placed in the O-ring receiving groove is attached to an opening of the connecting member.

7. A liquid jet apparatus, comprising:
the liquid jet head according to claim 1;
transfer means for transferring a recording medium in a main scan direction;
a liquid tank for storing liquid;
a pump for pressing liquid from the liquid tank into the liquid jet head for supply; and
a moving mechanism for causing the liquid jet head to move in an auxiliary scan direction which is orthogonal to the main scan direction.
